(19) United States
(12) Patent Application Publication
(10) Pub. No.: US 2018/0279592 A1
(43) Pub. Date: Oct. 4, 2018

(54) Fishing Lure Assembly

(71) Applicant: Michael McNeill, Metropolis, IL (US)

(72) Inventor: Michael McNeill, Metropolis, IL (US)

(21) Appl. No.: 15/472,951

(22) Filed: Mar. 29, 2017

(51) Int. Cl. A01K 85/00; A01K 83/00; A01K 91/14; A01K 91/04; A01K 95/00

(52) U.S. Cl. CPC A01K 85/00; A01K 83/00; A01K 95/00; A01K 91/04; A01K 91/14

(57) ABSTRACT

A fishing lure assembly includes a leader that has a first end and a second end. The first end forms a closed loop attachable to a fishing line. The leader extends through a first bead and a second bead such that the first and second beads are slidably positioned on the leader between the first and second ends. A wire has an upper end and a lower end. The wire is attached to and extends away from the leader. The upper and lower ends each are formed into closed hoops. The wire has a first twisted area adjacent to the upper end and a second twisted area adjacent to the second end. A hook is attached to the lower end and comprises a treble hook.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to fishing lure devices and more particularly pertains to a new fishing lure device for attracting and catching fish.

### BRIEF SUMMARY OF THE INVENTION

An embodiment of the disclosure meets the needs presented above by generally comprising a leader that has a first end and a second end. The first end forms a closed loop configured to be attached to a fishing line. The leader extends through a first bead and a second bead such that the first and second beads are slidably positioned on the leader between the first and second ends. A wire has an upper end and a lower end. The wire is attached to and extends away from the leader. The upper and lower ends each are formed into closed hoops. The wire has a first twisted area adjacent to the upper end and a second twisted area adjacent to the second end. A hook is attached to the lower end and comprises a treble hook.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a fishing lure assembly according to an embodiment of the disclosure.

FIG. 2 is a rear view of an embodiment of the disclosure.

FIG. 3 is a front view of an embodiment of the disclosure.

### DETAILED DESCRIPTION OF THE INVENTION

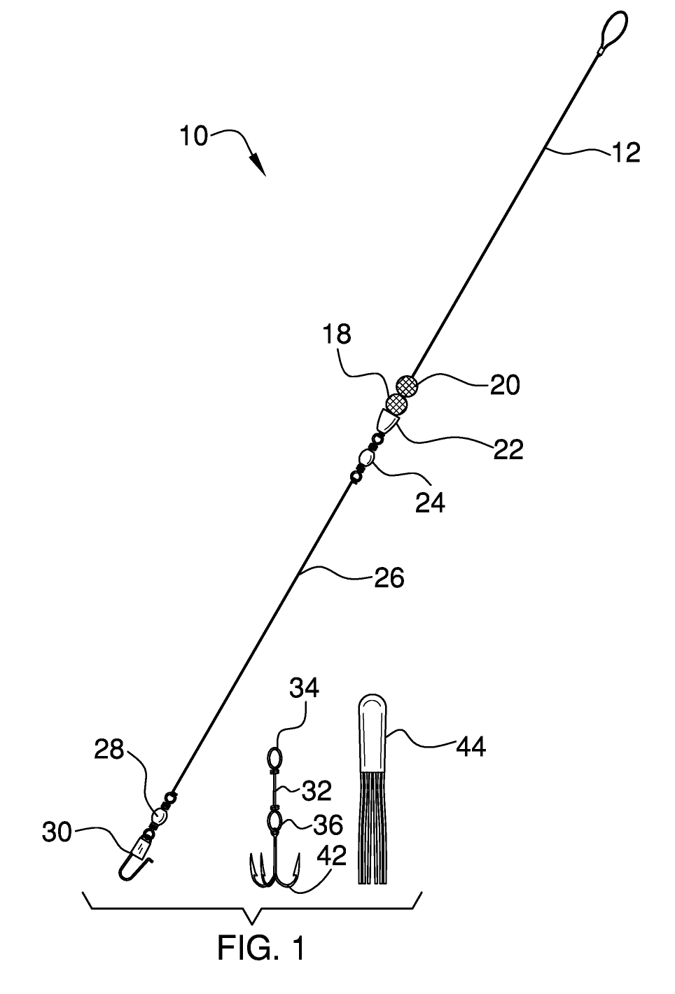

With reference now to the drawings, and in particular to FIGS. 1 through 3 thereof, a new fishing lure device embodying the principles and concepts of an embodiment of the disclosure and generally designated by the reference numeral 10 will be described.

As best illustrated in FIGS. 1 through 3, the fishing lure assembly 10 generally comprises a leader 12 having a first end 14 and a second end 16. The first end 14 forms a closed loop configured to be attached to a fishing line. The leader 12 may be conventional and comprise #8 monofilament having a closed loop being a 0.5 inch loop and the leader being about 5.0 inches long.

A first bead 18 and a second bead 20 are each placed on the leader 12 such that the leader 12 extends through the first 18 and second 20 beads. The first 18 and second 20 beads are thereby slidably positioned on the leader 12 between the first 14 and second 16 ends. Each of the first 18 and second 20 beads is translucent and has a size of about 0.25 inches in diameter. Though the first 18 and second 20 beads may overall have a spherical shape, each of the beads 18, 20 is actually a polyhedron having at least eight sides, may be defined as “diamond shaped,” and which typically will have no more than twenty sides. The first bead 18 may be clear while the second bead 20 may be colored a red color.

A weight 22 is also attached to the leader 12. The leader 12 extends through the weight 22 so that the weight 22 is slidable on the leader 12. More particularly, the weight 22 may comprise what is referred to as a 1/16 slip sinker or also known as a bullet sinker. The weight 12 is positioned between the second end 16 and the first 18 and second 20 beads.

A first swivel 24 is attached to the second end 16 of the leader 12. The first swivel 24 may comprise #12 barrel swivel having ends which are each permanently closed loops. A tether 26 is attached to the first swivel 24 such that the first swivel 24 is positioned between the tether 26 and the leader 12. The tether 26 may comprise another #8 monofilament having a length of about 5.0 inches.

A second swivel 28 is attached to the tether 26 such that the tether 26 is positioned between the first 24 and second 28 swivels. The second swivel 28 may comprise a #12 snap swivel conventionally having one permanently closed end and a second end forming an openable clasp 30 for engaging other loops.

A wire 32 is provided having an upper end 34 and a lower end 36. The upper end 34 is attached to the second swivel 28 distal to the tether 26. The upper 34 and lower 36 ends each are formed into closed hoops wherein the upper end 34 may be oval shaped and the lower end 36 may be round shaped. The wire 34 has a first twisted area 38 adjacent to the upper end 34 and a second twisted area 40 adjacent to the lower end 36. The twisted ends form loops around a central, straight portion of the wire 32. The wire 32 has an overall length between 1.0 inches and 0.5 inches and may more particularly be equal to about 0.75 inches.

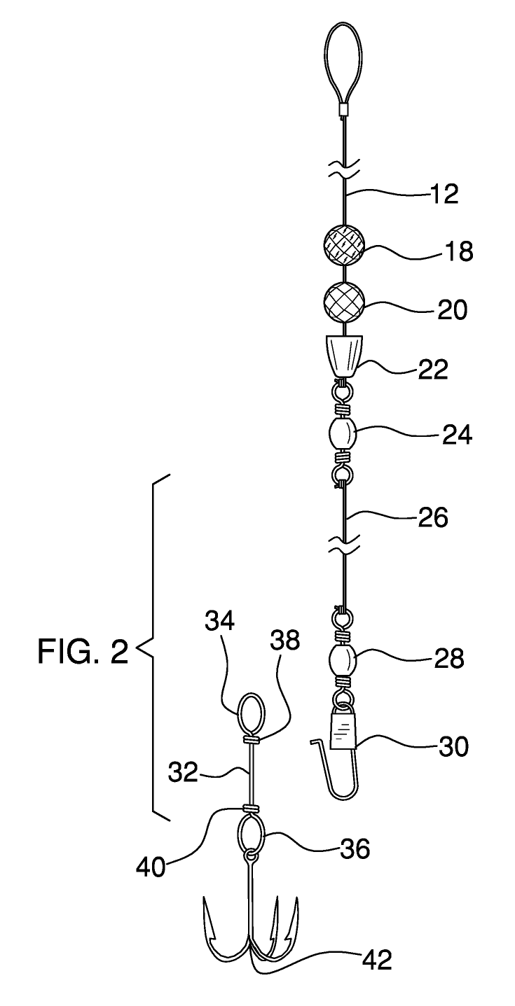

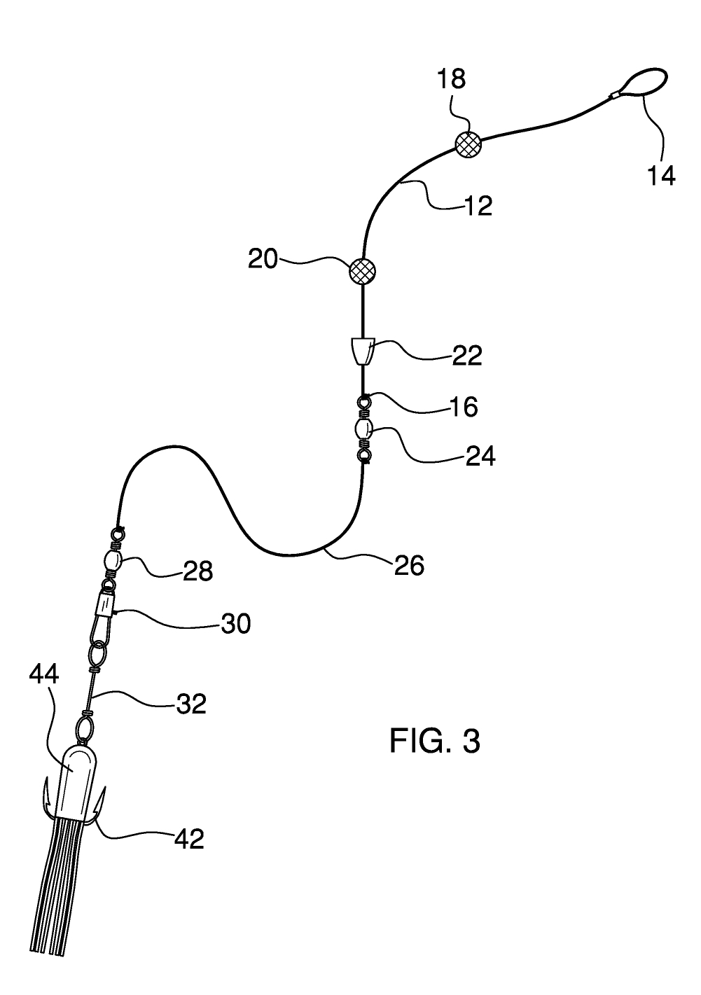

A hook 42 is attached to the lower end 36. The hook 36 may be any conventional hook 42, however it is preferred that the hook comprise a treble hook. The hook and wire may be formed as a unitary structure as shown in FIG. 2 such that the hook is not removable from the wire 32. The hook may comprise a size #12 treble hook. A skirt 44 may be positioned on the hook 42 as can be seen in FIG. 3.

In use, the assembly 10, is attached to fishing line in a conventional manner and may be fished by casting or trolling. The unique combination of the twisted wire 32 and treble hook 42 effectively attracts and catches many variations of fish and in particular freshwater fish.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fishing lure assembly comprising:
a leader having a first end and a second end, said first end forming a closed loop configured to be attached to a fishing line;
a first bead and a second bead, said leader extending through said first and second beads such that said first and second beads are slidably positioned on said leader between said first and second ends;
a wire having an upper end and a lower end, said wire being attached to and extending away from said leader, said upper and lower ends each being formed into closed hoops, said wire having a first twisted area adjacent to said upper end and a second twisted area adjacent to said lower end; and
a hook being attached to said lower end, said hook comprising a treble hook.

2. The fishing lure assembly according to claim 1, wherein each of said beads is translucent.

3. The fishing lure assembly according to claim 2, wherein each of said beads is a polyhedron having at least eight sides.

4. The fishing lure assembly according to claim 3, wherein said first bead is clear, said second bead is colored a red color.

5. The fishing lure assembly according to claim 1, further including a weight being attached to said leader, said leader extending through said weight, said weight being positioned between said second end and said first and second beads.

6. The fishing lure assembly according to claim 1, further including:
a first swivel being attached to said second end of said leader;
a tether being attached to said first swivel such that said first swivel is positioned between said tether and said leader;
a second swivel being attached to said tether such that said tether is positioned between said first and second swivels; and
wherein said wire is attached directly to said second swivel such that said second swivel is positioned between said wire and said tether.

7. A fishing lure assembly comprising:
a leader having a first end and a second end, said first end forming a closed loop configured to be attached to a fishing line;
a first bead and a second bead, said leader extending through said first and second beads such that said first and second beads are slidably positioned on said leader between said first and second ends, each of said beads being translucent, each of said beads being a polyhedron having at least eight sides, said first bead being clear, said second bead being colored a red color;
a weight being attached to said leader, said leader extending through said weight, said weight being positioned between said second end and said first and second beads;
a first swivel being attached to said second end of said leader;
a tether being attached to said first swivel such that said first swivel is positioned between said tether and said leader;
a second swivel being attached to said tether such that said tether is positioned between said first and second swivels;
a wire having an upper end and a lower end, said upper end being attached to said second swivel distal to said tether, said upper and lower ends each being formed into closed hoops, said wire having a first twisted area adjacent to said upper end and a second twisted area adjacent to said lower end, said wire having a length between 1.0 inches and 0.5 inches; and
a hook being attached to said lower end, said hook comprising a treble hook.
